(19) United States
(12) Patent Application Publication
(10) Pub. No.: US 2022/0369842 A1
(43) Pub. Date: Nov. 24, 2022

(54) DEVICE FOR PEELING FRUITS AND ROOT VEGETABLES

(71) Applicant: Woon Ki BAEK, Daejeon (KR)

(72) Inventor: Woon Ki BAEK, Daejeon (KR)

(21) Appl. No.: 17/773,591

(22) PCT Filed: Oct. 27, 2020
(86) PCT No.: PCT/KR2020/014689

§ 371 Date: Apr. 29, 2022

(30) Foreign Application Priority Data
Oct. 29, 2019 (KR) 10-2019-0135271

(51) Int. Cl. A47J 17/02; B26D 3/28; B26D 7/26; A47J 25/00; A47J 17/10

(52) U.S. Cl. CPC A47J 17/02; B26D 3/282; B26D 7/2614; A47J 25/00; A47J 17/10

(57) ABSTRACT

The present invention relates to a device which is for peeling fruits and root vegetables and has the effect of easily removing the entire peel of a fruit or root vegetable at once so that none of the peel remains, and cutting the fruit or root vegetable into multiple pieces.

### TECHNICAL FIELD

The present invention relates to a device for peeling fruits and root vegetables, capable of easily removing an entire peel of a fruit or a root vegetable at once without allowing the peel to remain, and cutting the fruit or the root vegetable into a plurality of pieces.

### BACKGROUND ART

In general, fruits are also referred to as fruitage, and the fruits have rich fruit flesh and fruit juice, sweet tastes, and good fragrances.

The fruits have been used as desserts that are frequently provided in large-scale cafeterias of schools, companies, and the like, and in order to ingest the fruit, a peel of the fruit has to be removed due to spraying of agricultural chemicals and the like.

In order to remove the peel of the fruit, a fruit knife is mainly used, and it is very difficult to remove the peel with a uniform thickness while there is a slight difference depending on a skill level, so that an edible portion of the fruit may be removed together with the peel, and there is always a risk of a cut injury because a blade of the fruit knife is exposed to an outside.

For this reason, a peeler that is more convenient than the fruit knife may be used to remove the peel of the fruit with a thickness that is uniform to a certain degree. However, since the thickness of the peel of the fruit to be removed may vary according to a change in a force applied to the peeler, it may be difficult for a user to maintain a constant force while the peel is completely removed, so that the peel may not be removed with a constant thickness.

In order to solve the above problems, Korean Utility Model Registration No. 20-0274700 has proposed a fruit peel remover capable of freely adjusting a thickness of a peel to be removed according to a type of a fruit and a preference of a user.

However, in a case of Korean Utility Model Registration No. 20-0274700, the peel of the fruit is removed while rotating the fruit in a state where a portion of the peel of the fruit makes contact with a peel removal unit, which has an inconvenience of manually moving a location of the peel removal unit to a removal target peel region in order to remove an entire peel of the fruit, so that the entire fruit peel may not be removed at once, and some fruit peels may remain on the fruit when a skill level of the user is low.

### DETAILED DESCRIPTION OF THE INVENTION

### Technical Problem

The present invention has been devised to solve the problems described above, and an object of the present invention is to provide a device for peeling fruits and root vegetables, capable of easily removing an entire peel of a fruit or a root vegetable at once without allowing the peel to remain, and cutting the fruit or the root vegetable into a plurality of pieces.

### Technical Solution

To achieve the objects described above, according to the present invention, there is provided a device for peeling a fruit, the device including: a fixing ring in which the fruit is accommodated; a plurality of peeling blade units radially provided on an inner side of the fixing ring so as to be movable toward a center portion of the fixing ring on the inner side of the fixing ring, and configured to peel a peel of the fruit; and an elastic member for elastically supporting the peeling blade units toward the center portion of the fixing ring.

In this case, the peeling blade units may include a plurality of upper peeling blade units and a plurality of lower peeling blade units, which are provided on an inner upper portion and an inner lower portion of the fixing ring so as to be horizontally movable toward the center portion of the fixing ring on the inner upper portion and the inner lower portion of the fixing ring, respectively.

In particular, the lower peeling blade units may be alternately arranged with the upper peeling blade units under the upper peeling blade units.

In addition, guide bars extending toward an inner surface of the fixing ring to penetrate through the fixing ring so as to guide a movement of each of the peeling blade units may be formed on one side and an opposite side of each of the peeling blade units, respectively.

Furthermore, the device for peeling the fruit may further include: a core separation unit provided on an inner center portion of the fixing ring to separate a fruit core from the fruit; and a plurality of cutting units radially provided between an outer surface of the core separation unit and an inner surface of the fixing ring to cut the fruit accommodated in the fixing ring into a plurality of pieces, and configured to guide movements of the peeling blade units in which the peeling blade units are provided so as to be movable toward the center portion of the fixing ring on the inner side of the fixing ring.

Moreover, a stopper protruding upward of the cutting unit and making contact with each of the peeling blade units to restrict the movement of each of the peeling blade units so that the peeling blade units are spaced apart from the core separation unit by a predetermined distance may be formed on an upper portion of the cutting unit.

Further, the device for peeling the fruit may further include a handle unit including a covering in which the fixing ring is provided, and handles formed on one side and an opposite side of the covering, respectively.

In addition, the device for peeling the fruit may further include a support unit on which the fruit accommodated in the fixing ring is seated.

In this case, the support unit may be formed on an outer surface thereof with an annular latching/fixing groove to which each of the peeling blade units is latched and fixed.

In addition, according to the present invention, there is provided a device for peeling a root vegetable, the device including: a fixing ring in which the root vegetable is accommodated; a plurality of peeling blade units radially provided on an inner side of the fixing ring so as to be movable toward a center portion of the fixing ring on the inner side of the fixing ring, and configured to peel a peel of the root vegetable; and an elastic member for elastically supporting the peeling blade units toward the center portion of the fixing ring.

### Advantageous Effects

According to the present invention, a plurality of peeling blade units radially provided on an inner side of a fixing ring to move toward a center portion of the fixing ring on the inner side of the fixing ring by an elastic force of an elastic member may be used, so that an entire peel of a fruit or a root vegetable can be easily removed at once without allowing the peel to remain, and the fruit or the root vegetable can be cut into a plurality of pieces.

### DESCRIPTION OF THE DRAWINGS

FIG. 1 is a perspective view schematically showing a device for peeling fruits and root vegetables according to one embodiment of the present invention.

FIG. 2 is a plan view of FIG. 1.

FIG. 3 is a plan view schematically showing a guide bar according to one example.

FIGS. 4 and 5 are perspective views schematically showing a peeling blade unit including an upper peeling blade unit and a lower peeling blade unit.

FIG. 6 is a plan view of FIG. 5.

FIG. 7 is a perspective view schematically showing a core separation unit and a cutting unit.

FIG. 8 is a sectional view taken along line A-A of FIG. 7 and schematically showing a state where a stopper is formed on an upper portion of the cutting unit.

FIG. 9 is a perspective view schematically showing a covering.

FIG. 10 is a separation perspective view schematically showing a state where a fixing ring is separated from a support unit.

FIG. 11 is a coupling perspective view schematically showing a state where the fixing ring is coupled to the support unit.

FIG. 12 is a coupling sectional view taken along line B-B of FIG. 11.

FIGS. 13 to 16 are sectional views schematically showing a process of peeling a peel of a fruit or a root vegetable.

FIG. 17 is a perspective view schematically showing a fruit cut into a plurality of pieces.

FIG. 18 is a perspective view schematically showing a state where a handle unit according to another example is coupled to the fixing ring.

FIG. 19 is a separation perspective view of FIG. 18.

### BEST MODE

Hereinafter, preferred embodiments of the present invention will be described in more detail with reference to the accompanying drawings. In addition, the scope of the present invention is not limited to the following embodiments, and various modifications can be made by those of ordinary skill in the art without departing from the technical gist of the present invention.

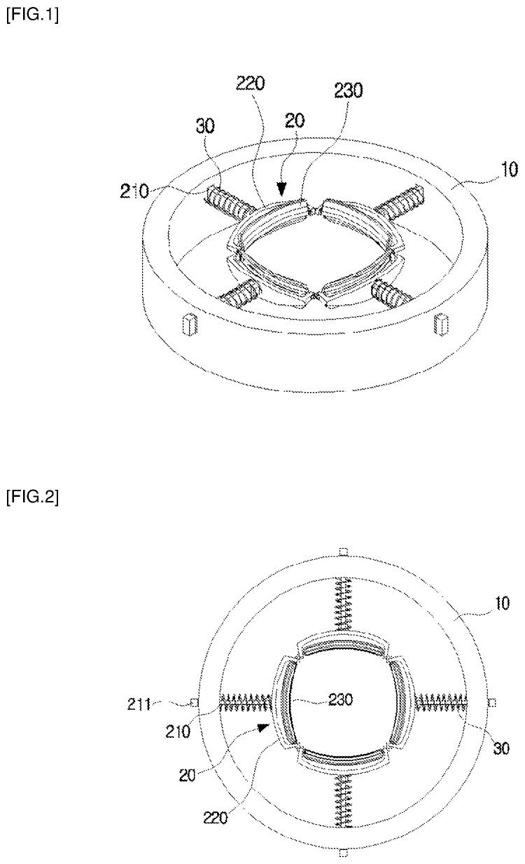

FIG. 1 is a perspective view schematically showing a device for peeling fruits and root vegetables according to one embodiment of the present invention.

According to one embodiment of the present invention, as shown in FIG. 1, a device for peeling fruits and root vegetables may largely include a fixing ring 10, a plurality of peeling blade units 20, and an elastic member 30.

First, a fruit such as an apple or a pear from which a peel is to be removed, or a root vegetable such as a potato or a sweet potato from which a peel is to be removed may be accommodated in the fixing ring 10.

Next, the peeling blade units 20 may be radially provided on an inner side of the fixing ring 10 so as to be horizontally movable toward a center portion of the fixing ring 10 on the inner side of the fixing ring 10, and configured to peel a peel of the fruit.

FIG. 2 is a plan view of FIG. 1.

According to one example, as shown in FIGS. 1 and 2, the peeling blade unit 20 may include a movement plate 210, a movement frame 220, and a peeling blade 230.

The movement plate 210 may horizontally extend toward the center portion of the fixing ring 10 by a predetermined length on the inner side of the fixing ring 10.

Movement plates 210 may be radially provided on the fixing ring 10 at a predetermined interval to penetrate through the fixing ring 10 so as to horizontally move toward the center portion of the fixing ring 10 on the inner side of the fixing ring 10.

One side of the movement plate 210 may be exposed to an outer side of the fixing ring 10 by a predetermined length, and a stopper body 211 may be formed at one end of the movement plate 210.

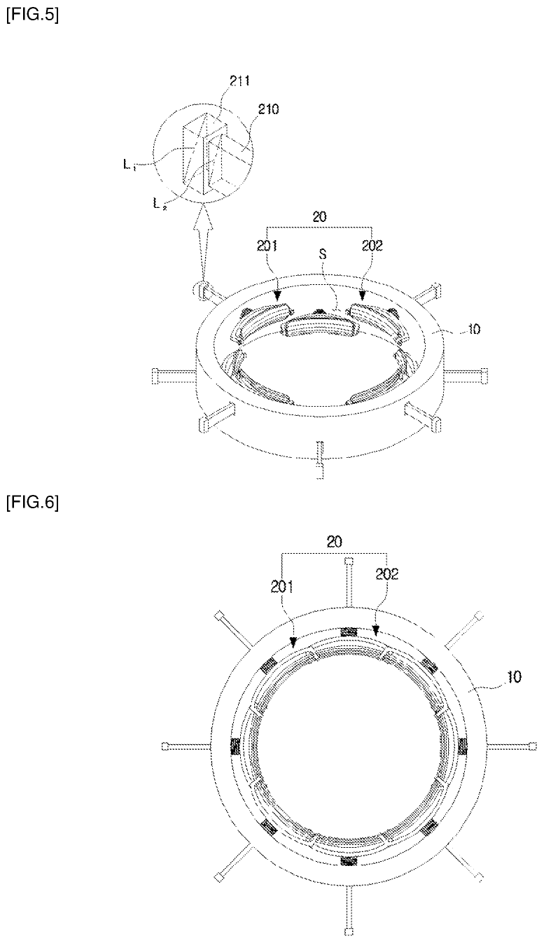

A diagonal length (L₁ of FIG. 5) of the stopper body 211 may be greater than a diagonal length (L₂ of FIG. 5) of the movement plate 210.

The stopper body 211 may make contact with an outer surface of the fixing ring 10 to restrict a movement of the one end of the movement plate 210 so that the one end of the movement plate 210 may not be drawn inward of the fixing ring 10.

The movement frame 220 may extend in a front-rear direction of the movement plate 210 by a predetermined length.

A front end and a rear end of the movement frame 220 may be bent toward the center portion of the fixing ring 10 by a predetermined length, respectively.

An opposite end of the movement plate 210 may be connected to a middle portion of one outer surface of the movement frame 220.

The peeling blade 230 may extend in the front-rear direction along the movement frame 220 by a predetermined length.

Front and rear sides of the peeling blade 230 may be axially coupled to front and rear sides of the movement frame 220, respectively, so that the peeling blade 230 may be rotatably provided between the front end and the rear end of the movement frame 220.

Next, the elastic member 30 may elastically support the peeling blade units 20 toward the center portion of the fixing ring 10.

While the movement plate 210 is accommodated in the elastic member 30, various types of elastic members 30 such as springs may be provided between an inner surface of the fixing ring 10 and the middle portion of the one outer surface of the movement frame 220.

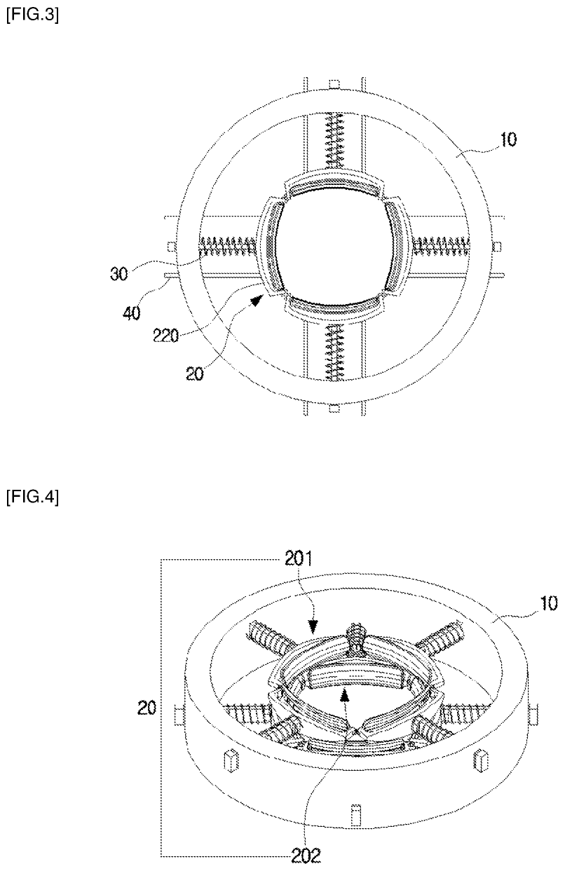

FIG. 3 is a plan view schematically showing a guide bar according to one example.

Next, in order to enable the peeling blade units 20 to smoothly move toward the center portion of the fixing ring 10 on the inner side of the fixing ring 10 by an elastic force of the elastic member 30 without being shaken, as shown in FIG. 3, guide bars 40 may be formed on front and rear sides of the one outer surface of the movement frame 220 of each of the peeling blade units 20, respectively.

The guide bars 40 may horizontally extend toward the inner surface of the fixing ring 10 along the movement plate 210 by a predetermined length to penetrate through the fixing ring 10 so as to guide a movement of each of the peeling blade units 20.

FIGS. 4 and 5 are perspective views schematically showing a peeling blade unit including an upper peeling blade unit and a lower peeling blade unit, and FIG. 6 is a plan view of FIG. 5.

Next, in order to improve peeling efficiency of the peeling blade units 20, as shown in FIGS. 4 to 6, the peeling blade units 20 may largely include a plurality of upper peeling blade units 201 and a plurality of lower peeling blade units 202.

The upper peeling blade units 201 may be radially provided on an inner upper portion of the fixing ring 10 so as to be horizontally movable toward the center portion of the fixing ring 10 on the inner side of the fixing ring 10.

The lower peeling blade units 202 may be radially provided on an inner lower portion of the fixing ring 10 so as to be horizontally movable toward the center portion of the fixing ring 10 on the inner side of the fixing ring 10.

Although the lower peeling blade units 202 may be arranged under the upper peeling blade units 201 so as to be located on the same vertical line as the upper peeling blade units 201, preferably, in order to easily remove an entire peel of a fruit or a root vegetable at once without allowing the peel to remain through the peeling blade units 20 including the upper peeling blade units 201 and the lower peeling blade units 202, as shown in FIG. 5, the lower peeling blade units 202 may be alternately arranged with the upper peeling blade units 201 under the upper peeling blade units 201.

To this end, according to one example, the lower peeling blade units 202 may be arranged under a space S formed between the upper peeling blade units 201.

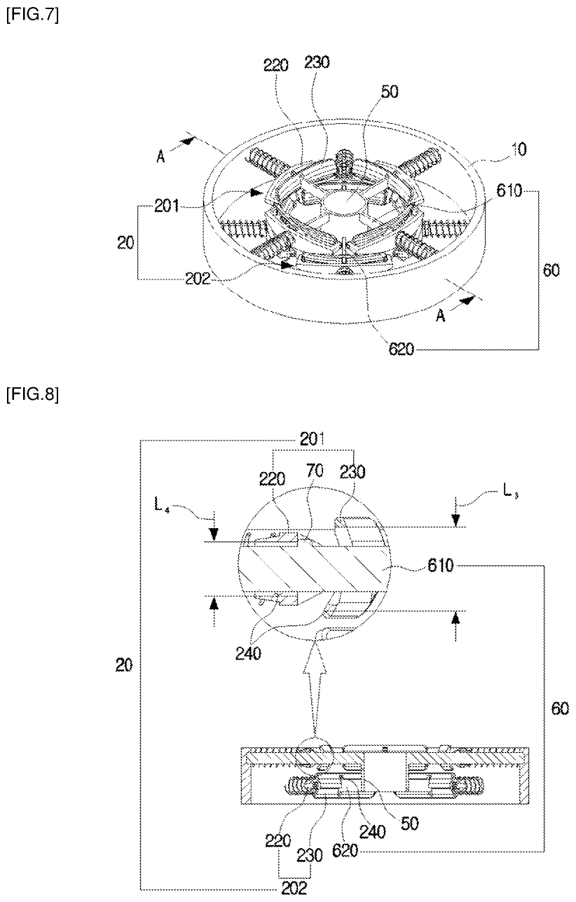

FIG. 7 is a perspective view schematically showing a core separation unit and a cutting unit.

Next, in order to peel a peel of the fruit or the root vegetable and easily cut the fruit or the root vegetable into a plurality of pieces, as shown in FIG. 7, the device for peeling the fruits and the root vegetables may include a core separation unit 50 and a cutting unit 60.

The core separation unit 50 may extend in a vertical direction of the fixing ring 10 in a tubular shape by a predetermined length so as to be vertically provided in an inner middle portion of the fixing ring 10, and may separate a fruit core, which is a center portion of the fruit, from the fruit or separate a root vegetable core, which is a center portion of the root vegetable, from the root vegetable.

A plurality of cutting units 60 may be radially provided between an outer surface of the core separation unit 50 and the inner surface of the fixing ring 10 while being erected on the inner side of the fixing ring 10 so as to cut the fruit or the root vegetable accommodated in the fixing ring 10 into a plurality of pieces.

In order to improve cutting efficiency of the fruit or the root vegetable, the cutting unit 60 may include an upper cutting unit 610 and a lower cutting unit 620.

A plurality of upper cutting units 610 may be radially provided between an upper outer surface of the core separation unit 50 and an upper inner surface of the fixing ring 10.

A plurality of lower cutting unit 620 may be radially provided between a lower outer surface of the core separation unit 50 and a lower inner surface of the fixing ring 10.

Although the lower cutting units 620 may be arranged under the upper cutting units 610 so as to be located on the same vertical line as the upper cutting units 610, preferably, in order to cut the fruit or the root vegetable into a larger number of pieces through the cutting units 60 including the upper cutting units 610 and the lower cutting units 620, the lower cutting units 620 may be alternately arranged with the upper cutting units 610 under the upper cutting units 610.

To this end, according to one example, the lower cutting units 620 may be arranged under the space S formed between the upper peeling blade units 201 together with the lower peeling blade units 202.

Meanwhile, when the core separation unit 50 and the cutting unit 60 are provided on the inner side of the fixing ring 10, according to another example, as shown in FIG. 7, the peeling blade unit 20 may include the movement frame 220 and the peeling blade 230 and may be provided on the cutting unit 60 so as to be movable toward the center portion of the fixing ring 10 on the inner side of the fixing ring 10.

FIG. 8 is a sectional view taken along line A-A of FIG. 7 and schematically showing a state where a stopper is formed on an upper portion of the cutting unit.

As shown in FIG. 8, guide slits 240 extending in the vertical direction of the fixing ring 10 by a predetermined length may be formed in a middle portion of the movement frame 220 of the upper peeling blade unit 201 and a middle portion of the peeling blade 230 of the upper peeling blade unit 201, respectively.

The upper cutting unit 610 of the cutting unit 60 may pass through the guide slits 240 of each of the upper peeling blade units 201.

The upper cutting unit 610 of the cutting unit 60 may guide a movement of each of the upper peeling blade units 201.

In addition, guide slits 240 extending in the vertical direction of the fixing ring 10 by a predetermined length may be formed in a middle portion of the movement frame 220 of the lower peeling blade unit 202 and a middle portion of the peeling blade 230 of the lower peeling blade unit 202, respectively.

The lower cutting unit 620 of the cutting unit 60 may pass through the guide slits 240 of each of the lower peeling blade units 202.

The lower cutting unit 620 of the cutting unit 60 may guide a movement of each of the lower peeling blade units 202.

Next, in order to maintain a state where the peeling blade units 20 are spaced apart from the outer surface of the core separation unit 50 by a predetermined distance, as shown in FIG. 8, a stopper 70 protruding upward of the cutting unit 60 by a predetermined length to restrict the movement of each of the peeling blade units 20 may be formed on an upper portion of the cutting unit 60.

According to one example, the stopper 70 may be formed on an upper center portion of the cutting unit 60 so as to be located between the movement frame 220 and the peeling blade 230 of each of the peeling blade units 20.

A vertical length L₃ of the guide slit 240 of the peeling blade 230 may be longer than a vertical length L₄ of the guide slit 240 of the movement frame 220 so that the stopper 70 may pass through the guide slit 240 of the peeling blade 230 of the peeling blade unit 20 while being prevented from passing through the guide slit 240 of the movement frame 220 of the peeling blade unit 20.

The stopper 70 may make contact with a region of the movement frame 220 at a periphery of an upper portion of the guide slit 240 of the movement frame 220 of the peeling blade unit 20 so as to maintain the state where the peeling blade units 20 are spaced apart from the outer surface of the core separation unit 50 by a predetermined distance.

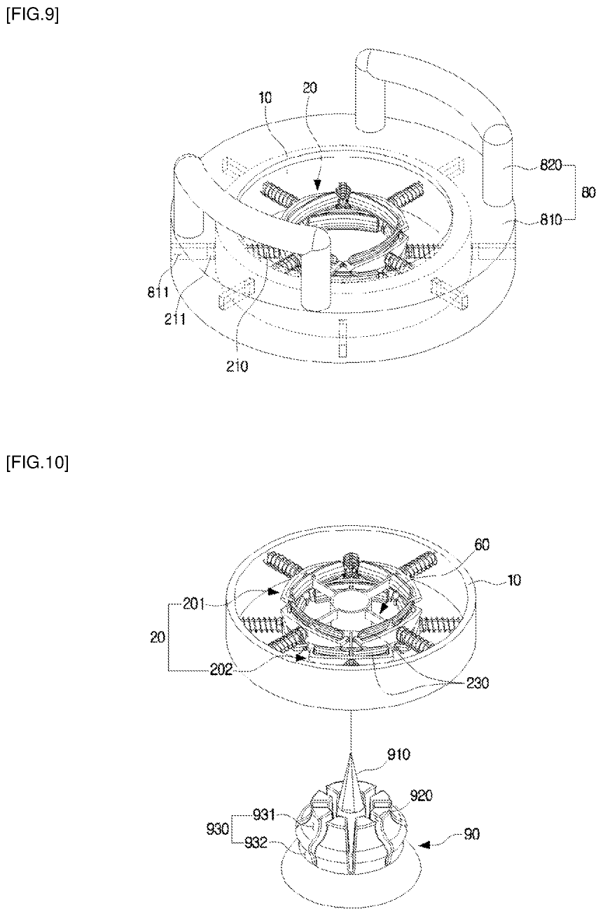

FIG. 9 is a perspective view schematically showing a covering.

Next, the device for peeling the fruits and the root vegetables may include a handle unit 80 in which the fixing ring 10 is accommodated.

According to one example, as shown in FIG. 9, the handle unit 80 may largely include a covering 810 and a handle 820.

While the covering 810 surrounds the outer side of the fixing ring 10, the fixing ring 10 may be provided in the covering 810.

The covering 810 may be formed therein with a plurality of guide grooves 811 radially and horizontally extending along the movement plate 210 by a predetermined length, in which the movement plate 210 and the stopper body 211 of each of the peeling blade units 20 moving toward the center portion of the fixing ring 10 on the inner side of the fixing ring 10 are accommodated in the guide groove 811.

The guide groove 811 may guide movements of the movement plate 210 and the stopper body 211 of each of the peeling blade units 20.

Handles 820 may be formed on one upper side and an opposite upper side of the covering 810, respectively.

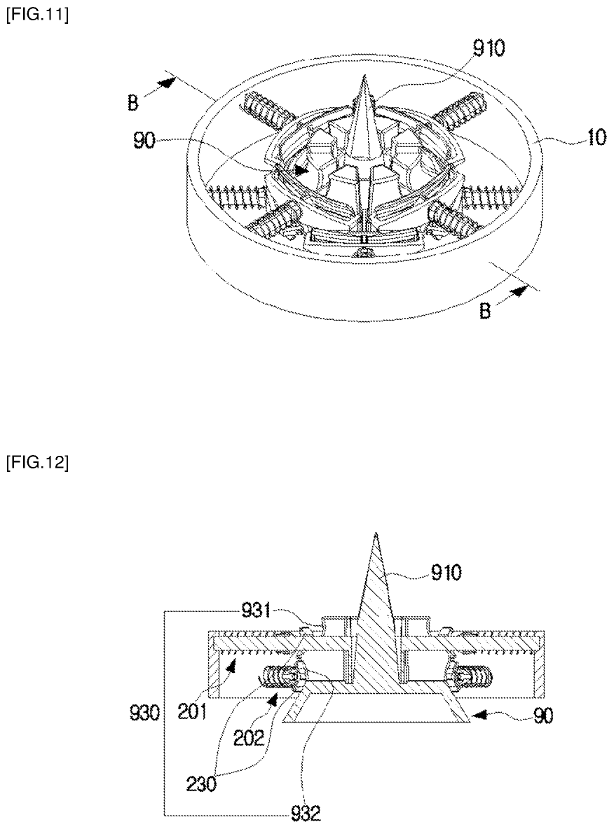

FIG. 10 is a separation perspective view schematically showing a state where a fixing ring is separated from a support unit, FIG. 11 is a coupling perspective view schematically showing a state where the fixing ring is coupled to the support unit, and FIG. 12 is a coupling sectional view taken along line B-B of FIG. 11.

Next, as shown in FIGS. 10 to 12, the device for peeling the fruits and the root vegetables may include a support unit 90 detachably coupled to the fixing ring 10.

A lower portion of the fruit or the root vegetable accommodated in the fixing ring 10 may be seated and fixed onto an upper portion of the support unit 90.

A position fixing shaft 910 extending in a vertical direction of the support unit 90 by a predetermined length may be formed on a center portion of the support unit 90.

An upper portion of the position fixing shaft 910 may extend upward of the support unit 90 by a predetermined length so as to be exposed toward an upper outer portion of the support unit 90.

The upper portion of the position fixing shaft 910 may be gradually sharpened from a lower portion of the support unit 90 toward the upper portion of the support unit 90.

While the upper portion of the position fixing shaft 910 is inserted and fixed into a lower center portion of the fruit or the root vegetable by a predetermined depth, the fruit or the root vegetable may be more stably seated and fixed onto the upper portion of the support unit 90 without fluctuation.

A plurality of insertion grooves 920 may be radially formed with a predetermined depth on an upper region of the support unit 90 at a periphery of an upper center portion of the support unit 90.

The cutting units 60 may be inserted into the insertion grooves 920, respectively.

In order to more easily transport and store the fixing ring 10 and the handle unit 80 together with the support unit 90 and prevent the fixing ring 10 coupled to the support unit 90 from being separated from the support unit 90 too easily, the support unit 90 may be formed on an outer surface thereof with an annular latching/fixing groove 930 to which the peeling blade 230 of each of the peeling blade units 20 is latched and fixed.

The annular latching/fixing groove 930 may include an annular upper latching/fixing groove 931 and an annular lower latching/fixing groove 932.

The peeling blade 230 of each of the upper peeling blade units 201 may be latched and fixed to the annular upper latching/fixing groove 931 while being accommodated in the annular upper latching/fixing groove 931.

The peeling blade 230 of each of the lower peeling blade units 202 may be latched and fixed to the annular lower latching/fixing groove 932 while being accommodated in the annular lower latching/fixing groove 932.

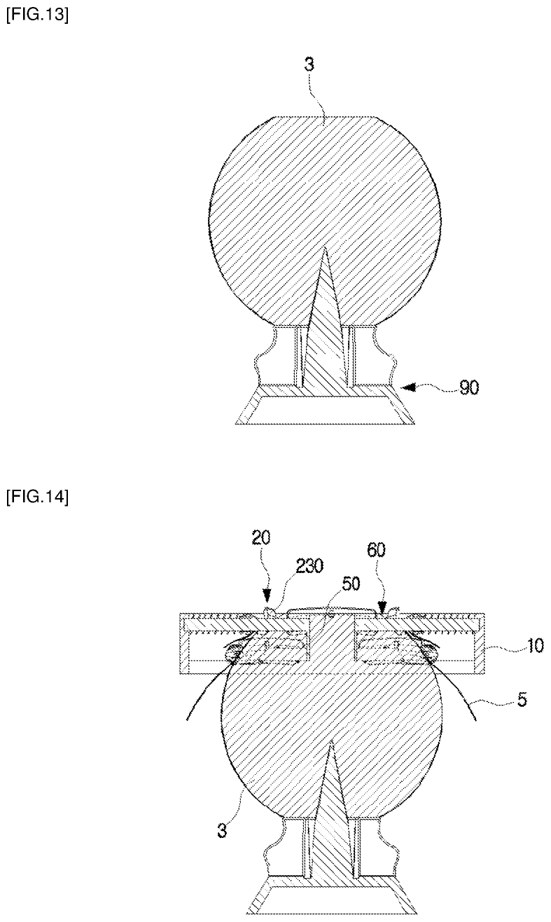

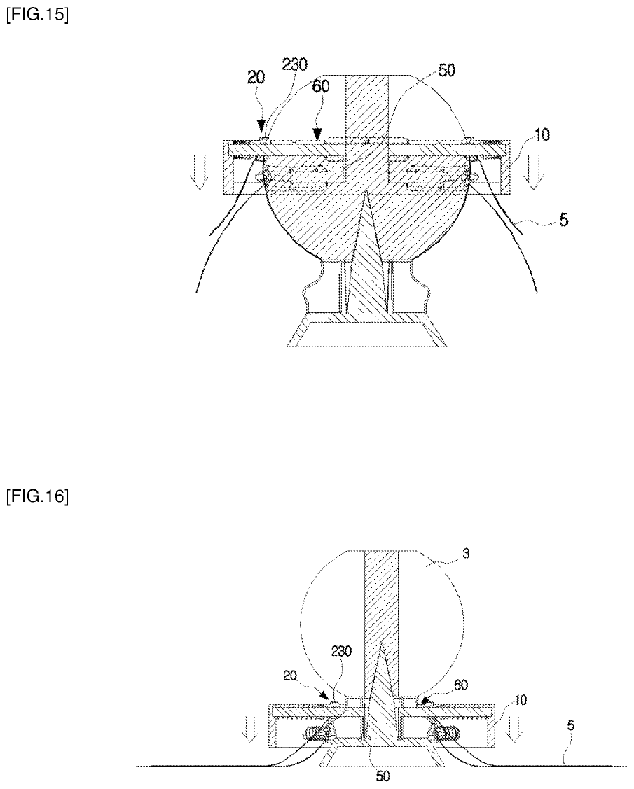

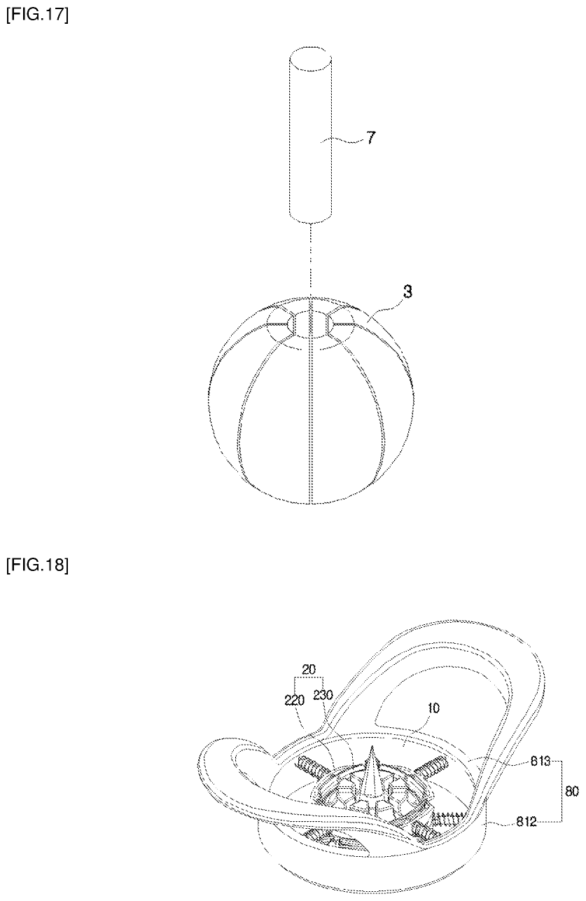

FIGS. 13 to 16 are sectional views schematically showing a process of peeling a peel of a fruit or a root vegetable, and FIG. 17 is a perspective view schematically showing a fruit cut into a plurality of pieces.

As shown in FIG. 13, a fruit 3 or a root vegetable may be seated and fixed onto the upper portion of the support unit 90.

While an upper portion of the fruit 3 is accommodated in the fixing ring 10, as shown in FIGS. 14 to 16, a user may use the handle 820 of the handle unit 80 to allow the fixing ring 10 to descend downward of the fixing ring 10 together with the handle unit 80.

In this case, as the peeling blade 230 of each of the peeling blade units 20 descends in close contact with a surface of the fruit 3 or the root vegetable while moving toward the center portion of the fixing ring 10 on the inner side of the fixing ring 10 according to a surface curvature of the fruit 3 or the root vegetable, the peeling blade 230 may easily remove an entire peel 5 of the fruit 3 or the root vegetable at once without allowing the peel 5 to remain, and simultaneously, the core separation unit 50 may separate a fruit core 7 or a root vegetable core from the fruit or the root vegetable, and the cutting unit 60 may cut the fruit 3 or the root vegetable into a plurality of pieces as shown in FIG. 17.

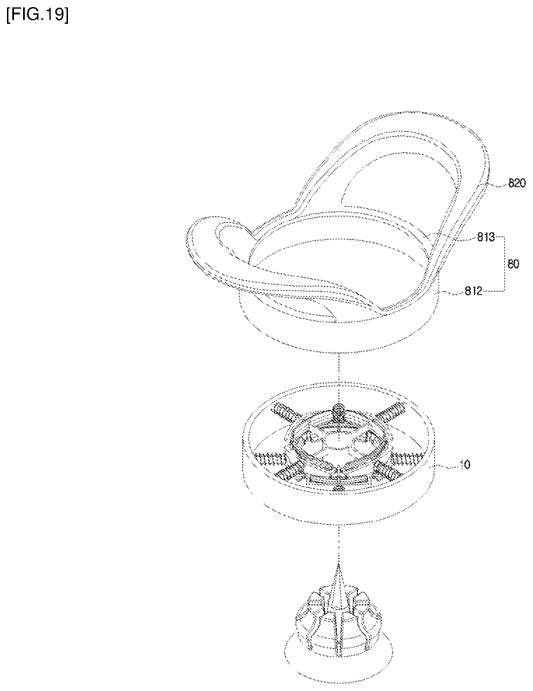

FIG. 18 is a perspective view schematically showing a state where a handle unit according to another example is coupled to the fixing ring, and FIG. 19 is a separation perspective view of FIG. 18.

Next, when the peeling blade unit 20 includes the movement frame 220 and the peeling blade 230 according to another example as described above, according to another example, the handle unit 80 may include a lower covering 812 and an upper covering 813 as shown in FIGS. 18 and 19.

The fixing ring 10 may be detachably accommodated in the lower covering 812.

The upper covering 813 may protrude inward of the lower covering 812 from an upper portion of the lower covering 812 by a predetermined length so as to be seated on an upper portion of the fixing ring 10.

The handles 820 of the handle unit 80 may be formed on one upper side and an opposite upper side of the upper covering 813, respectively.

### INDUSTRIAL APPLICABILITY

According to the present invention, a plurality of peeling blade units radially provided on an inner side of a fixing ring to move toward a center portion of the fixing ring on the inner side of the fixing ring by an elastic force of an elastic member may be used, so that an entire peel of a fruit or a root vegetable can be easily removed at once without allowing the peel to remain, and the fruit or the root vegetable can be cut into a plurality of pieces.

1. A device for peeling a fruit, the device comprising:
a fixing ring in which the fruit is accommodated;
a plurality of peeling blade units radially provided on an inner side of the fixing ring so as to be movable toward a center portion of the fixing ring on the inner side of the fixing ring, and configured to peel a peel of the fruit; and
an elastic member for elastically supporting the peeling blade units toward the center portion of the fixing ring.

2. The device of claim 1, wherein the peeling blade units include a plurality of upper peeling blade units and a plurality of lower peeling blade units, which are provided on an inner upper portion and an inner lower portion of the fixing ring so as to be horizontally movable toward the center portion of the fixing ring on the inner upper portion and the inner lower portion of the fixing ring, respectively.

3. The device of claim 2, wherein the lower peeling blade units are alternately arranged with the upper peeling blade units under the upper peeling blade units.

4. The device of claim 1, wherein guide bars extending toward an inner surface of the fixing ring to penetrate through the fixing ring so as to guide a movement of each of the peeling blade units are formed on one side and an opposite side of each of the peeling blade units, respectively.

5. The device of claim 1, further comprising:
a core separation unit provided on an inner center portion of the fixing ring to separate a fruit core from the fruit; and
a plurality of cutting units radially provided between an outer surface of the core separation unit and an inner surface of the fixing ring to cut the fruit accommodated in the fixing ring into a plurality of pieces, and configured to guide movements of the peeling blade units in which the peeling blade units are provided so as to be movable toward the center portion of the fixing ring on the inner side of the fixing ring.

6. The device of claim 5, wherein a stopper protruding upward of the cutting unit and making contact with each of the peeling blade units to restrict the movement of each of the peeling blade units so that the peeling blade units are spaced apart from the core separation unit by a predetermined distance is formed on an upper portion of the cutting unit.

7. The device of claim 1, further comprising a handle unit including a covering in which the fixing ring is provided, and handles formed on one side and an opposite side of the covering, respectively.

8. The device of claim 1, further comprising a support unit on which the fruit accommodated in the fixing ring is seated.

9. The device of claim 8, wherein the support unit is formed on an outer surface thereof with an annular latching/fixing groove to which each of the peeling blade units is latched and fixed.

10. A device for peeling a root vegetable, the device comprising:
a fixing ring in which the root vegetable is accommodated;
a plurality of peeling blade units radially provided on an inner side of the fixing ring so as to be movable toward a center portion of the fixing ring on the inner side of the fixing ring, and configured to peel a peel of the root vegetable; and
an elastic member for elastically supporting the peeling blade units toward the center portion of the fixing ring.
